(19) United States
(12) Patent Application Publication
(10) Pub. No.: US 2024/0338975 A1
(43) Pub. Date: Oct. 10, 2024

(54) Accurate Digital Centration For Fitting of Prescription Lenses From A Photo

(71) Applicants: Shenchang Eric Chen, Bellevue, WA (US); Wheitsu Helen Tahn, Bellevue, WA (US); Brian Wei Chen, Bellevue, WA (US)

(72) Inventors: Shenchang Eric Chen, Bellevue, WA (US); Wheitsu Helen Tahn, Bellevue, WA (US); Brian Wei Chen, Bellevue, WA (US)

(21) Appl. No.: 18/632,246

(22) Filed: Apr. 10, 2024

Related U.S. Application Data
(60) Provisional application No. 63/458,225, filed on Apr. 10, 2023.

(51) Int. Cl. G06V 40/18; G02C 13/00; G06T 7/11; G06T 7/60; G06T 7/73; G06T 11/00; G06V 10/44; G06V 40/16

(52) U.S. Cl. CPC G06V 40/18; G02C 13/003; G06T 7/11; G06T 7/60; G06T 7/73; G06T 11/00; G06V 10/44; G06V 40/171; G06T 2207/30201; G06T 2210/12

(57) ABSTRACT

A method for computing centration measurements based on a digital photo, including receiving a digital photo of the face of a person wearing glasses, where the glasses have two lenses of equal size and a visible frame that surrounds each lens, where the wearer is facing the device that captured the photo, obtaining information about the frame size of the glasses, detecting facial landmarks for the face, extracting a bounding box for each of the two lenses, and computing a set of centration measurements that can be provided to a glasses manufacturer.

### BACKGROUND OF THE INVENTION

Digital centration is a process used in the eyewear industry to obtain optical measurements to ensure that the prescription lenses included in eyeglasses or glasses, provide optimal visual performance, comfort, and prescription accuracy. The process typically involves using specialized equipment, such as a digital pupillometer, to measure the position of the wearer's pupils relative to an eyeglasses frame, and then using this information to determine the correct position for the lenses in the frame.

Digital centration typically requires several key optical measurements as follows:

Interpupillary Distance or Binocular Pupil Distance (PD)—measures the distance between the centers of the pupils, to ensure that the lenses are positioned correctly in front of the eyes. There are two types of PD: (1) Distance (or Far) PD refers to the distance between the pupils when a wearer is viewing a distant object. Eye doctors, e.g. optometrists, use Distance PD to create distance vision glasses. Near PD refers to the distance between the pupils, measured on the spectacle plane, when a wearer is looking at a near object such as the page of a book or a computer screen when reading. PD may be used non-specifically, i.e. as a general measurement that is not specific to either Distance PD or Near PD, such as in the case of self-measurement, as described hereinbelow which provides a rough measure.

Monocular Pupil Distance (MPD)—measures the distance between the center of a pupil and the bridge of the nose, to ensure that the optical center of each lens is aligned with the center of each pupil. Thus, there are two MPD values, one for the right pupil and one for the left pupil. Thus, Distance PD is the sum of the two MPD values.

Segment height (or fitting height)—refers to the vertical distance from the bottom of the lens to the top of the bifocal or progressive segment, to ensure that the reading portion of the lens is located in the correct position for optimal vision correction.

Vertex distance (VD), also known as Black Vertex Distance (BVD)—refers to the distance between the back surface of the lens and the front surface of the eye of a wearer, when the eyeglasses are being worn, to ensure that the effective power of the lens is correct. Vertex distance is typically in the range of 10-16 mm.

FIG. 1 illustrates the relationship between the aforementioned key optical measurements. FIG. 1 illustrates the two eyeballs, Eye 1 and Eye 2 in relation to an observer or camera, Eye 3. In the figure, distance a is the Monocular pupil distance (MPD) for one pupil. Distance b is the MPD measured on the spectacle plane SP.

WD refers to the working distance, which is the distance from eye 3 to the spectacle plane SP. WD is typically in the range of 35-40 cm.

Spectacle plane (SP), as used herein, refers to a plane that contacts the inner, or back, lens surface of the glasses, i.e. the surface closest to the eyes.

Distance c is the distance from the front surface of the cornea to the center of rotation of the eye. This value is normally assumed to be 13.5 mm.

The vertex distance, i.e. the distance from the front surface of the cornea to the spectacle plane typically ranges from 10-16 mm.

These measurements are usually taken by a qualified optician or eye doctor in a clinic. Online eyewear sellers use different methods to obtain these measurements from customers who are buying at home, including:

Self-measurement-Some online eyewear sellers provide detailed instructions on how to measure PD and/or MPD at home using a ruler or other measuring tools. Customers can then provide these measurements when placing their order.

Smartphone app-Some online eyewear sellers allow customers to use a smartphone app to take pictures of their face. The photos are then analyzed, and key facial features are extracted. To obtain an accurate scale, the photo often needs to be taken with a credit card, or another object of known size, which is placed or held next to the eyes. Many smartphones, such as some versions of the APPLE IPHONE, have depth sensors, which can be used to obtain the measurements, thus eliminating the use of a credit card.

While these methods can be effective, they are not always as accurate as measurements taken in person by a qualified optician or eye doctor. For example, for accurate prescription lens fitting, the errors in MPD and segment height measurements should be within 1 mm; however, self-measuring PD with a ruler can introduce errors ranging up to 4 mm, according to the results of at least one study.

Another challenge for home measurement is that segment height and vertex distance measurements can only be taken with the eyeglasses on so they are usually omitted for at-home measurements.

As a result, some online eyewear sellers offer a “try before you buy” option, allowing customers to test the eyeglasses for a certain period and return them if they are not satisfied. In such cases, inaccurate measurements may result in poor prescription fitting and higher return rates.

For these reasons, a simple digital centration method that allows a customer to purchase eyewear online and which obtains all the necessary optical measurements accurately by taking pictures of the customer's face, and without requiring a customer to hold a credit card or another external object near their face, is desirable.

### SUMMARY OF THE INVENTION

The invention is a method and computer system that processes a single photo of the face of a subject wearing a pair of eyeglasses with a known frame size to compute optical measurements for digital centration.

The system uses advanced computer vision and image processing technology to detect facial features, pupil centers, and frame contours in the photo. Given the known frame size of the eyeglasses as a reference, PD, MPD and segment heights of the wearer can be estimated with an average error of less than 1 mm.

While the method described requires only a single photo as input, it can also process multiple photos of the same subject to improve accuracy.

The invention includes a method for computing centration measurements based on a digital photo, including receiving a digital photo of the face of a person wearing glasses, where the glasses have two lenses of equal size and a visible frame that surrounds each lens, where the wearer is facing the device that captured the photo, obtaining information about the frame size of the glasses, detecting facial landmarks for the face, extracting a bounding box for each of the two lenses, and computing a set of centration measurements that can be provided to a glasses manufacturer.

### BRIEF DESCRIPTION OF DRAWINGS

Non-limiting and non-exhaustive embodiments of the present invention are described with reference to the following drawings. In the drawings, like reference numerals refer to like parts throughout the various figures unless otherwise specified.

FIG. 1 illustrates the relationship between key optical a.

FIG. 2 is a system diagram of one embodiment of a digital centration system (DCS).

FIG. 3 is a flow diagram for one embodiment of an overall method that performs a digital centration method based on a single input photo of a wearer.

FIG. 4A illustrates a portion of a temple of a pair of glasses that shows its frame size numbers.

FIG. 4B illustrates the relationship of a frame's size numbers to distances on the glasses.

FIG. 5A is a photo of the face of an individual.

FIG. 5B shows a triangular face mesh extracted from the photo of the face.

FIG. 6A illustrates a frame region mask for a pair of glasses.

FIG. 6B illustrates the results of the rectification step as applied to two lens contours.

FIG. 7 illustrates several key relationships used to compute Near PD and segment height.

FIG. 8 illustrates the relationship between near PD and distance PD as well as other distances required to compute centration measurements.

FIG. 9A is an embodiment of a mobile user interface that instructs a person to take a photo of a wearer.

FIG. 9B is an embodiment of a mobile user interface that instructs a person to identify and enter frame size numbers for a pair of measurement glasses.

The figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF THE INVENTION

The invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the invention may be embodied as methods, processes, systems, or devices. The following detailed description is, therefore, not to be taken in a limiting sense.

As used herein the following terms have the meanings given below:

Glasses, prescription glasses, pair of glasses are used interchangeably herein to refer to a pair of glasses with prescription lenses made specifically for the wearer.

Wearer or user—refers to a person who wears a pair of glasses, has a photo taken and the measurements are computed based on a photo of the wearer wearing a pair of glasses.

The system and method described herein pertain to the computation of measurements of the wearer's eyes which will subsequently be used to create a pair of prescription glasses for the wearer. The system and method doesn't include the details of the manufacturing process that creates the prescription glasses, and which uses the computed measurements.

### Operational View the Digital Centration System

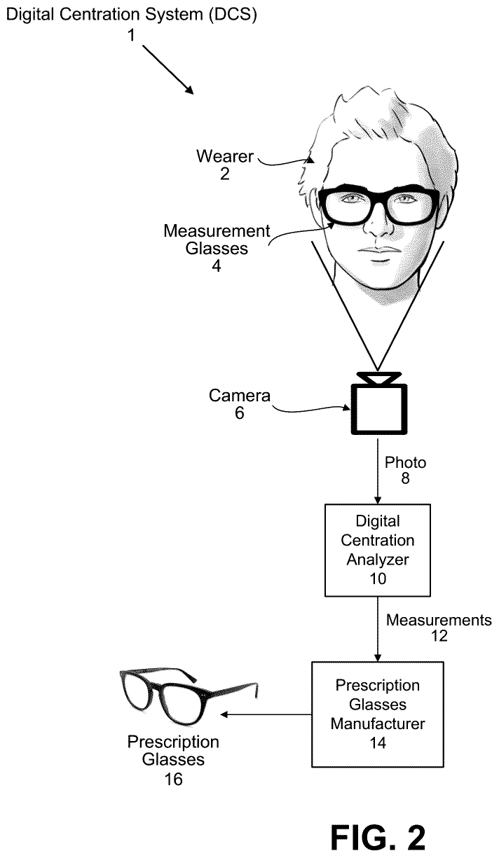

FIG. 2 is a system diagram of one embodiment of a digital centration system (DCS) 1. A wearer 2 wears a pair of measurement glasses 4 and faces a camera 6. Camera 6 is a digital camera or other capture device that takes one or more photos of wearer 2 and produces one or more photos 8. For purposes of simplicity the flow and method will be described for the case where a single photo 8 is taken. If more than one photo is taken, then statistical techniques such as averaging can be used to improve accuracy. However, only a single photo is required by the centration method described hereinbelow to operate efficiently.

Measurement glasses 4 are used herein only as a reference with a known frame size to compute optical measurements for digital centration. These may be an existing pair of prescription glasses owned by wearer 2 or they may be provided to wearer 2 for the specific purpose of taking photo 8.

Photo 8 is a digital photo. If camera 6 is an analog device and takes an analog photo, e.g. a film negative, film slide, or print, then it is scanned to a digital format, resulting in photo 8 in digital format.

Photo 8 in digital format is provided to a digital centration analyzer 10. This is typically a commercially available computer such as a WINDOWS personal computer, or a smartphone such as an IPHONE from APPLE COMPUTER that runs customized digital centration analysis software. It can also be a server computer or a cloud service, i.e. a service that is available across the Internet.

Digital centration analyzer 10 receives, or maintains, information about measurement glasses 8 and camera 6 and receives photo 8. Digital centration analyzer 10 analyzes photo 8, as described hereinbelow, and provides centration measurements 12 to a prescription glasses manufacturer. Prescription glasses manufacturer 14 creates a pair of prescription glasses 16.

It may be appreciated that parts of digital centration system 1 may be provided by a glasses manufacturer 14 or by a company or organization that provides a digital centration service as a standalone business.

### Processing Method

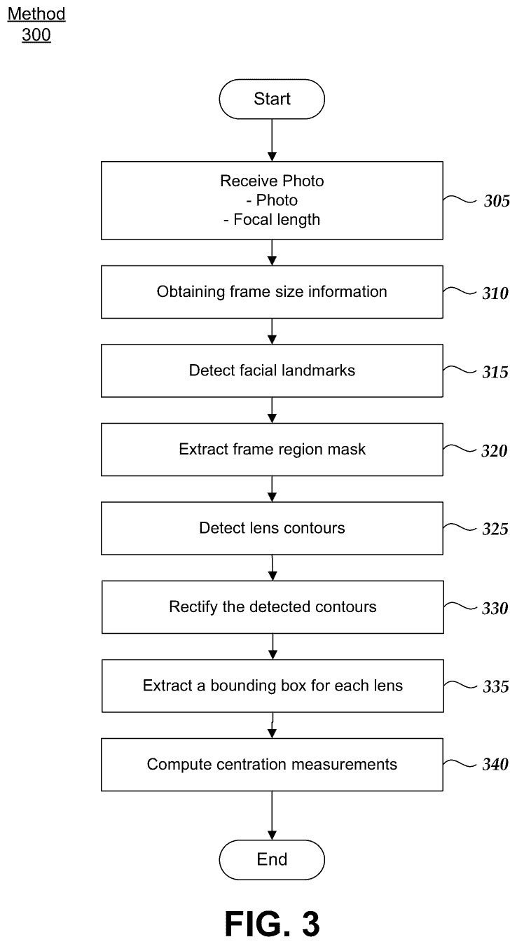

FIG. 3 is a flow diagram for one embodiment of an overall method 300 that performs a digital centration method using a single input photo of wearer 2. Method 300 is performed by digital centration analyzer 10. Method 300 generates, as outputs, centration measurements 12 that are typically provided to glasses manufacturer 14. If multiple photos of wearer 2 are provided as input, method 300 is repeated for each photo independently and the output measurements can be computed by averaging, or performing other statistical methods, the measurements obtained for each input photo.

At step 305 digital photo 8 of the wearer is received. The input data includes: (1) photo 8 of wearer 2 where wearer 2 is wearing measurement glasses 4, (2) optionally, the focal length of the camera used to take the photo. The focal length is typically embedded in the digital photo.

At step 310 the frame width of measurement glasses 4 is obtained. There are several ways to compute the frame width; also, in some cases, the frame width can be provided.

Generally, focal length and frame width data may be stored, or received, or, as in the case of frame width, it can be computed based on information extracted from photo 8.

At step 315 facial landmarks are detected. Facial landmarks typically include pupil centers and may also include iris contours, nose and lip identification. As described hereinbelow, a commercially available landmark detector may be used at this step.

At step 320 a frame region is extracted from photo 8.

At step 325 the two lens contours of measurement glasses 4 are detected inside the extracted frame region.

At step 330 the detected contours are rectified to correct for any perspective distortion, resulting in symmetrical contours.

Next, at step 335 a bounding box is determined for each rectified contour. It may be appreciated that the term bounding box, as used herein, refers to a set of values which can be used to define a left bounding box that encapsulates the left lens of the glasses and a right bounding box that defines a right bounding box that encapsulates the right lens of the glasses. For example, since a bounding box is a rectangle, it can be defined by 3 points or, in this case, pixel locations in a digital image, e.g. an upper right corner, a lower right corner and a left corner.

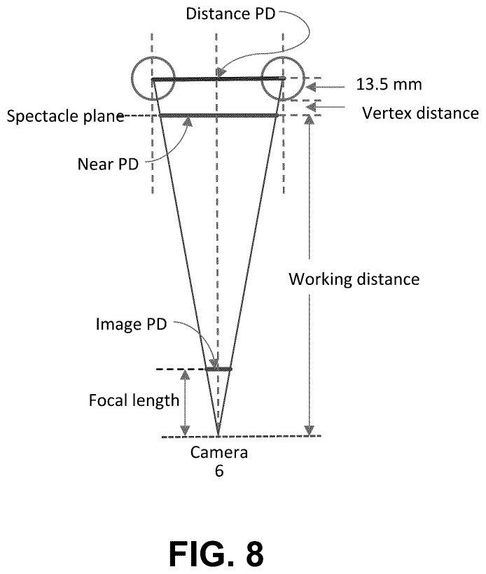

At step 340 centration measurements 12 are computed. These measurements are typically (1) near PD and segment height, and (2) distance PD and MPD. In other embodiments, different measurements or alternative measurements, such as those illustrated hereinbelow in FIG. 8 may also be provided.

Generally, method 300 determines a bounding box that encloses each lens region or contour of measurement glasses 4 and then computes a number of centration measurements 12 that can be used to manufacture a custom-fitted pair of glasses. In certain embodiments, one or more of steps 320, 325 and 330 are performed to improve the accuracy of the resulting centration measurements prior to determining the bounding boxes. However, there may be cases where one or more of steps 320, 325, and 330 are skipped, combined, or performed in a different order. For example, in certain embodiments one or more of steps 320, 325, 330 are combined or performed by a machine learning model, such as convolutional neural networks (CNN), which has been extensively trained and performs one or more of these steps as part of model execution. While such embodiments are not explicitly addressed herein, generally, use of a machine learning model or other algorithms that rearrange the order or eliminate the need to individually perform one or more of steps 320, 325 and 330 are within the scope and spirit of the subject invention. Each of the steps in method 300 are now described in greater detail.

### Photo of Wearer's Face

There are several requirements for obtaining a satisfactory photo 8. Photo 8 should be of a person, wearer 2, who is directly facing the camera with minimal head tilt or rotation. Wearer 2 should be wearing a pair of measurement glasses, such as measurement glasses 4, preferably with visible rims since rimless or transparent rims may not work. As discussed hereinbelow, the method first estimates near PD. thus, to approximate reading condition, wearer 2 should be looking at, i.e. focusing on, the camera when photo 8 is taken. The capturing distance, i.e. the distance from the lens of camera 6 to the face of wearer 2, should be roughly 30-40 cm. This distance is approximately the same as the working distance or working distance plus vertex distance but does not have to be a precise value. Lighting conditions should be adequate to allow facial features, pupils, and the eyeglasses lens contours to be detectable by a digital image sensor, such as the sensors included in commercially available photographic equipment and mobile phones.

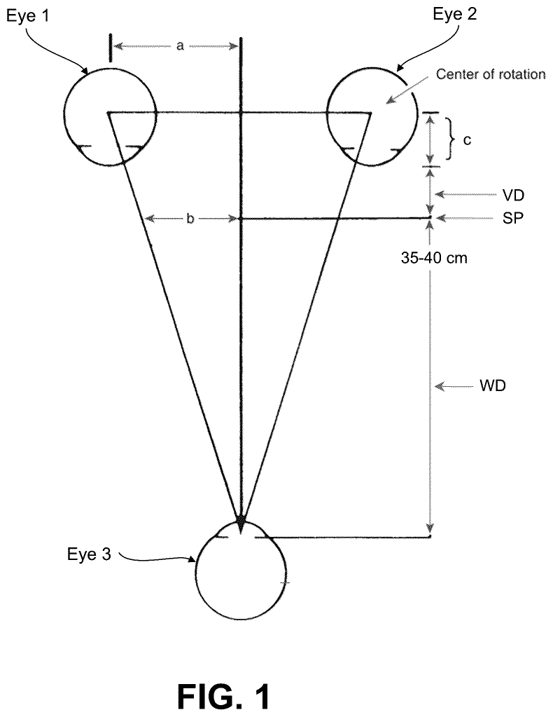

If the focal length of the photo is known, it can be used for computing the working distance, the distance between the camera and the spectacle plane as described with reference to FIG. 1. The focal length information is typically stored with a photo if it is taken with a smartphone camera or modern digital camera. It should be noted that focal length is only used to provide an estimate of the working distance for converting near PD to distance PD and is not strictly required if there is another means to estimate the distance. The focal length is not needed to compute segment heights, so it has no impact on their accuracy.

### Obtaining Frame Width

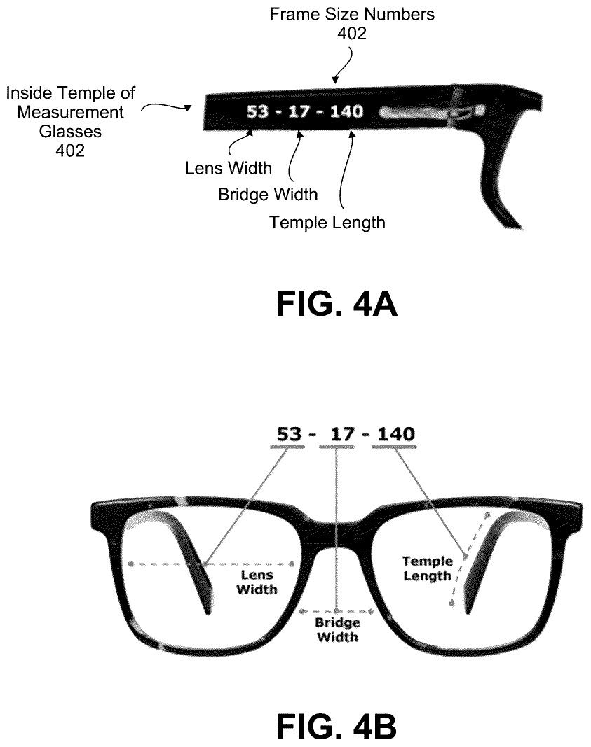

There are several ways to obtain the frame width of measurement glasses 4. As illustrated in FIG. 4A, for most glasses, frame size numbers 404 (lens width, bridge width, and temple length) are printed or engraved on the inside of a frame temple 402. FIG. 4B illustrates the relationship of the frame size numbers, lens width, bridge width, and temple length, to distances on the glasses. Frame width can thus be computed from the lens width and bridge width values using Equation 1, below:

$$frame width = 2 \times lens width + bridge width \qquad Equation 1$$

Thus, if a known pair of measurement glasses 4 are worn in photo 8 for which the frame size number are known then frame width is easily computed. If measurement glasses 4 are not known, e.g. wearer 2 simply uses a pair of glasses that he/she already possesses then wearer 2 can be prompted to (1) take a photo of the frame size numbers as they appear on the inside of the frame temple and (2) upload the photo that shows the frame size numbers.

Alternatively, a database of many known eyeglass frames can be used to obtain the frame size numbers. Each entry in the database stores the frame's shape contour and its corresponding frame size numbers. When a measurement is needed, photo 8 is processed to detect the frame shape, which is used to probe the database to see if there is a match. If a match is found the corresponding frame size numbers are retrieved from the database and the frame width is computed as described above.

Additionally, the frame width can be obtained by measuring the physical frame with a ruler.

### Facial Landmark Detection

Facial landmark detection is a well-established digital image processing method to detect key facial features, such as points around the eyes, nose, lips, iris and pupils in a photo. Many such methods exist already, and they are sufficiently robust to perform the processing of step 315 of method 300 even in the presence of eyeglasses. As used herein, facial landmark detection is used to extract pupil centers and iris contours.

One such facial landmark detection method is provided by a commercially available toolkit named FACE MESH by MEDIAPIPE. Further information about FACEMESH as well as the toolkit itself can be obtained from GOOGLE'S GITHUB website at the URL https://github.com/google/mediapipe/blob/master/docs/solutions/face_detection.md. FACE MESH is based on a face detector technology referred to as BLAZEFACE which is described in an article entitled “BlazeFace: Sub-Millisecond Neural Face Detection On Mobile GPU's” by V. Bazarevsky et al. The entirety of this paper is hereby incorporated by reference.

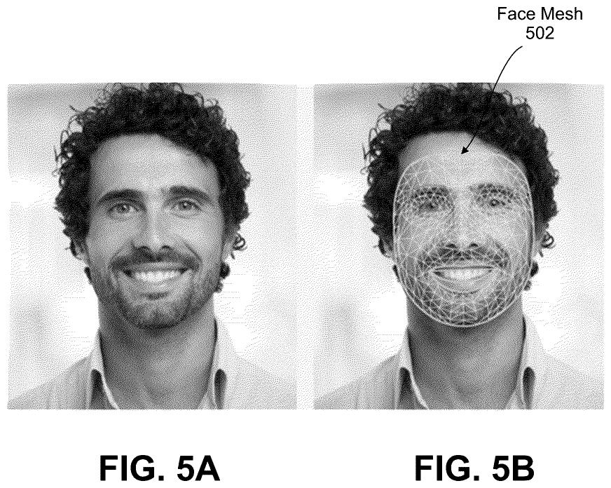

FIGS. 5A and 5B provide an example of the mesh approach used by FACE MESH. FIG. 5A is a photo of the face of an individual. FIG. 5B shows a triangular face mesh 502 that has been extracted from the photo. FACE MESH uses machine learning (ML) techniques to compute a 3D facial surface, from a single photo. It then extracts 3D facial landmarks.

### Frame Region Mask Extraction

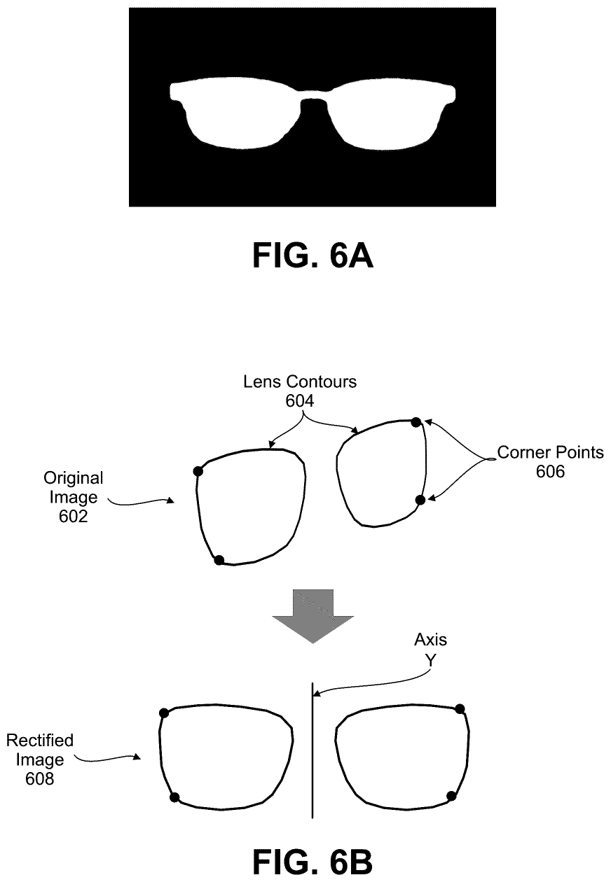

In certain embodiments, a mask of the region of photo 8 that exactly covers the frame of measurement glasses 4 is extracted. While this step is not required, it is desirable to separate the glasses frame region from the face to make the subsequent lens contour detection, performed at step 325, easier and more robust. FIG. 6A illustrates a frame region mask for a pair of glasses. The white area is the frame region mask that identifies the portion of the image covered by the glasses and frame.

Recent advances in AI-based semantic image segmentation, including the Segment Anything Model (SAM), for which information can be found at https://segment-anything.com/, enable automatic segmentation of an image by creating a series of image masks to classify pixels by their semantic labels (such as glasses). This article is hereby incorporated by reference in its entirety. Using such technology, it is possible to obtain a precise sub-image that includes the frame by extracting only pixels that belong to the glasses mask.

In one embodiment, SAM is used to create a sub-image that defines a frame region mask for measurement glasses 4. It may be appreciated that when SAM is used step 315, detection of facial landmarks, is not performed since SAM uses machine learning to directly extract a frame region mask.

### Lens Contour Detection

At step 325 image edge detection is used to detect the edges of each of the two lens contours within the frame region mask area of photo 8. As used herein a lens contour is a vector of connected 2d points. Each point has XY coordinates of its position on the image and each contour forms a closed loop that traces the edge of the lens. In other embodiments, a contour may be defined differently, for example as a series of pixels or a series of bezier curves.

One such method for detecting the contours of lenses is disclosed in an article entitled “Eyeglasses Lens Contour Extraction from Facial Images Using an Efficient Shape Description” by D. Borza et al., available at “https://www.ncbi.nlm.nih.gov/pmc/articles/PMC3859084/. This article is hereby incorporated by reference in its entirety.

Another method for performing lens contour detection is disclosed in an article entitled “Magic Glasses: from 2D to 3D, by X. Yuan et al., and available at https://liuyebin.com/liuyebin_files/glasses.pdf. This article is hereby incorporated by reference in its entirety.

In certain embodiments, one or the other of the above cited methods are used to detect the two lens contours of the frame included in photo 8. Both have been used in various embodiments and have yielded acceptable results.

### Rectification of Lens Contours

For accurate measurements, the two lens contours detected in the preceding step should be symmetrical, and not have any perspective distortion. Since photo 8 is taken with an unknown head rotation, the frame surface may not be parallel to the imaging plane and may include perspective distortion. For this reason, step 330 rectifies or eliminates any perspective distortion.

One way to correct for the perspective distortion is to identify corner points in the detected contours, assuming they are planar, and use them to construct a homography matrix that transforms the contours to a rectified space so that the two contours are symmetrical. The homography matrix transforms the glasses based on the lens corner points to view where the corner points are symmetric with respect to a vertical axis (referred to as axis Y in FIG. 6B). A discussion of homography is available in an article entitled “Understanding Homography (a.k.a Perspective Transformation)” by S Lee, and can be found at https://towardsdatascience.com/understanding-homography-a-k-a-perspective-transformation-cacaed5ca17. This article is hereby incorporated by reference in its entirety.

FIG. 6B illustrates the results of the rectification step as applied to two lens contours. The original image 602 has significant perspective distortion due to the angle at the which the photo was taken, i.e. the angle of the spectacle plane relative to the camera. The rectification process identifies corner points 606 in the two lens contours 604 detected in the previous step and constructs a homography matrix. Applying the homography matrix to the original image results in a rectified image 606 where the two lens contours are symmetric about a vertical axis Y.

Since the lens contour corner detection may contain errors, in certain embodiments, the above two processes: contour detection and rectification are repeated iteratively until the desired errors (the symmetry difference between the two sets of contour points) is within a target threshold.

Once an acceptable transformation matrix is found, it is applied to all the facial, pupil landmarks, and lens contour points so that all the coordinates are now in the rectified image space. As previously discussed, rectification step 330 is not performed in certain embodiments. However, in embodiments where step 330 is performed then subsequent use of the term “image space” as well as references to distances, measurements and points in the image refer to the rectified image. Examples of cases where rectification may not be required include when photo 8 is known to have been taken by a professional photographer or in an environment that reliably generates front facing photos of wearer 2 with no head tilt or rotation

### Compute Near PD and Segment Height

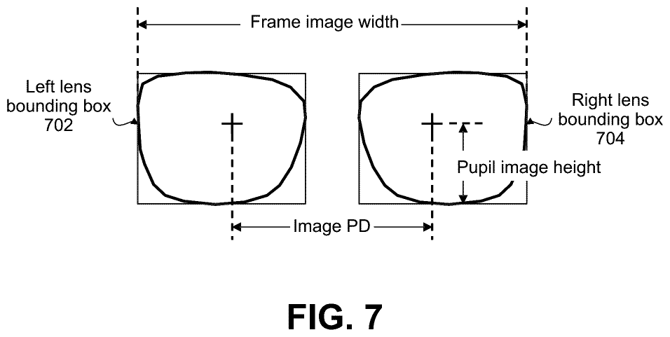

FIG. 7 illustrates several of the key relationships used to compute Near PD (Equation 2) and segment height (Equation 3). The key distances, measured in pixels, used to compute Near PD and segment height are distance between the two pupils, referred to as Image_PD, the width of the image of the frame, referred to as frame_image_width, and the distance from the bottom of a frame to the pupil center, referred to as pupil_image height. These distances are computed from the coordinates, in image space as measured in pixels, of the two bounding boxes, a left lens bounding box 702 and a right lens bounding box 704. Assuming the photo is captured at a working distance around 30-40 cm and the eyes are focused on the camera, the near PD is computed using Equation 2, below:

$$Near\_PD = Image\_PD * frame\_width / frame\_image \_width \qquad Equation 2$$

where frame_width is obtained at step 310 and is computed according to Equation 1, frame_image_width is the horizontal distance (in pixels) between the leftmost edge of the lens contour bounding boxes and the rightmost edge of the right contour bounding box, and Image_PD is the horizontal distance (in pixels) between the two pupil centers in photo 8. Assuming square pixels, segment height for each pupil is computed using Equation 3, below:

$$Segment\_height = pupil\_image \_height * frame\_width / frame\_image \_width \qquad Equation 3$$

where pupil_image_height is the vertical distance (in pixels) between the pupil center and the bottom edge of its lens bounding box in the image space and frame_width and frame_image_width are as previously described hereinabove.

### Compute Distance PD and MPD

Distance PD is related to near PD according to Equation 4, below:

$$Distance\_PD = \qquad Equation 4$$

$$Near\_PD * ( working\_distance + vertex\_distance + 13.5 mm ) /$$

$$working\_distance$$

In this embodiment, 13.5 mm is the assumed distance between the cornea front surface and the center of eye. In other embodiments, this distance may be measured or computed.

Working distance can be computed if the focal length of the camera is known. Otherwise, the working distance can be provided as input or is set to be an expected distance, such as 35 cm. It should be noted that the working distance is only used to convert near PD to distance PD and does not need to be very exact. An error of 5 cm in working distance estimate translates to around 0.5 mm conversion error. Working distance is computed according to Equation 5, below:

$$Working\_distance = focal\_length * frame\_width / frame\_image \_width \qquad Equation 5$$

Vertex_distance usually ranges from 10-16 mm but for the purpose of computing PD, using a nominal value of 13 mm is sufficient. Varying the vertex distances in the range results in an average PD deviation of about 0.5 mm from the nominal value, which is within an acceptable target error range.

MPD is computed from PD by using the ratio between the left and right pupils' horizontal distances to the center of the frame bridge, which is the midpoint of the two lens contour boxes.

The final output from DCS 1, referred to as centration measurements 12, typically include distance PD, MPD, near PD, segment heights, working distance, and vertex distance. Typically, prescription glasses manufacturer 14 specifies which centration measurements they require and these may include all of the aforementioned measurements 12 or slightly different measurements without departing from the scope and spirit of the invention.

FIG. 8 illustrates the relationship between near PD and distance PD as well as other distances required to compute centration measurements 12.

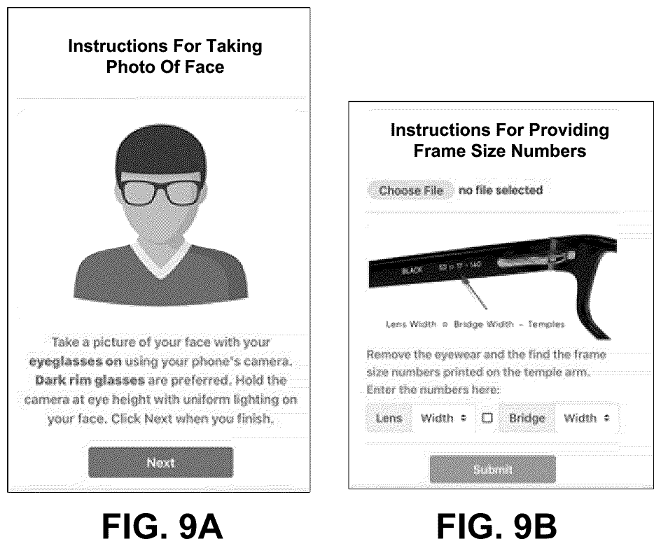

FIGS. 9A and 9B are embodiments of graphical user interfaces that instruct a user or wearer to provide information digital centration analyzer 10 that enables it to compute centration measurements 12. The graphical user interfaces are provided by digital centration analyzer to wearer 2 or another user as part of the capture process.

FIG. 9A is an embodiment of a mobile user interface that instructs a person to take a photo of wearer 2 following the previously discussed guidelines.

FIG. 9B is an embodiment of a mobile user interface that instructs a person to identify and enter frame size numbers, including the lens width and bridge width, for measurement glasses 4.

Upon reading this disclosure, those of skill in the art will appreciate that while particular embodiments and applications have been illustrated and described herein, the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A computer implemented method for computing centration measurements based on a digital photo taken by a capture device, comprising:
receiving a digital photo of the face of a person wearing glasses, wherein the glasses have a left lens and a right lens of equal size and a visible frame that surrounds each lens, wherein the wearer of the glasses is facing the capture device;
obtaining the frame width of the glasses;
detecting facial landmarks for the face of the wearer from the photo;
extracting a bounding box for each of the two lenses; and
based on the digital photo, the detected facial landmarks and the extracted bounding box for each lens, computing a set of centration measurements that can be provided to a glasses manufacturer and used to manufacture a pair of custom-fitted glasses.

2. The method of claim 1, wherein extracting a bounding box comprises:
extracting a frame region mask that identifies the minimum rectangular portion of the photo that includes the entirety of the frame of the glasses; and
detecting the contours of each of the two lenses; and
rectifying the digital photo based on the detected contours,
wherein extracting the bounding box for each lens is performed on the rectified digital photo and is based on the position of the corners of each lens within the rectified photo.

3. The method of claim 2, wherein rectification comprises:
identifying the corner points of each of the lens contours;
based on the determined corner points, determining a homography matrix that transforms digital photo such that the wearers face is forward facing with no tilt or rotation; and
applying the homography matrix to the digital photo to produce a rectified digital photo.

4. The method of claim 1, wherein the set of centration measurements include at least one measurement from the group consisting of distance PD, MPD, near PD, segment heights for each pupil, working distance, and vertex distance.

5. The method of claim 1, wherein detecting facial landmarks for the face of the wearer comprises:
obtaining the location of the centers of each of the wearers two pupils.

6. The method of claim 1, further comprising:
providing a user interface to a user that enables the user to provide information about the size of the glasses frame.

7. The method of claim 6, wherein the provided information includes the lens width and the bridge width.

8. The method of claim 6, wherein the frame width is computed from the provided information about the size of the glasses frame.

9. The method of claim 1, wherein one of the set of computed centration measurements is near interpupillary distance (Near PD) and Near PD is calculated as:
Near PD=Image_PD*frame width/frame_image_width
where frame_image_width is the horizontal distance (in pixels) between the left edges of the left lens contour bounding box and the right edge of the right lens contour bounding box, and Image_PD is the horizontal distance (in pixels) between the two pupil centers in photo.

10. The method of claim 1, wherein one of the set of computed centration measurements is the segment height for each photo and the segment height is calculated as:
segment height=pupil_image_height*frame width/frame_image_width
where pupil_image_height is the vertical distance (in pixels) between the pupil center to the bottom edge of its lens bounding box in the image space and frame_image_width is the horizontal distance (in pixels) between the left edges of the left lens contour bounding box and the right edge of the right lens contour bounding box.

11. The method of claim 9, wherein one of the set of computed centration measurements is the distance interpupillary distance (Distance PD) and Distance PD is calculated as:
Distance_PD=Near_PD*(working_distance+vertex_distance+13.5 mm)/working_distance
wherein the focal length of the capture device is not included in the digital photo and thus the working_distance value is set to an expected distance of 35 cm and vertex_distance is set to a value of 13 mm.

12. The method of claim 11 wherein the focal length of the capture device is included in the digital photo and the working distance is calculated as:
Working distance=focal_length*frame width/frame_image_width
